(19) United States
(12) Patent Application Publication
(10) Pub. No.: US 2011/0011055 A1
(43) Pub. Date: Jan. 20, 2011

(54) Jet engine air intake guard

(76) Inventor: Thomas Jay Troy, Glendale, CA (US)

Correspondence Address: Thomas Troy;#313, 589 Americana Way, Glendale, CA, 91210, US

(21) Appl. No.: 12/460,352

(22) Filed: Jul. 17, 2009

(51) Int. Cl. F02G 3/00

(52) U.S. Cl. 60/39.092

(57) ABSTRACT

A jet engine air intake guard takes the circumstance into consideration to protect a jet-engine air intake structure from being damaged by birds or any other foreign objects, including meteoritic debris and bullets during flight operations, said structure comprising a deflector, a steep dome-shaped device with sharply pointed forepart, a secondary device which is carefully designed to insert into the base component, in order to deflect birds or any foreign objects out of the air stream and to provide an adequate air intake to the jet-engine during use. According to the invention, the protective device also comprises a base component put over the air intake cowl being provided with stiffening means completely cover the air intake cowl to hold the protective device firmly while operating is being disclosed in the present application.

### BACKGROUND OF THE INVENTION

On Jan. 15, 2009, a major commercial airplane, US Airways Flight 1549 has made a forced landing on Hudson River in New York. The incident was caused by migratory Canada geese.

The migratory birds are among the largest species of bird in North America, with an estimated weight of about 8 pounds each. The determination that the birds were the 8-pound variety and not the 4-pound Brant geese is likely to comfort jet-engine designers, since the engines are designed to survive strikes from 4-pound birds.

More specifically, it was at least two female and one male geese flying at approximately 2,900 feet that got sucked into the two engines of the Airbus A320, disabling both engines and causing one of the more spectacular water landings in aviation history. Fortunately, all 155 people safely evacuated the jet.

The similar accidents frequently occurred in the past, and can be happened at any time without notice. However, the most people still dread of boarding on a commercial airplane nowadays. Before now, there were numerous inventions to attempting to solve this problem.

The present invention takes the circumstance into consideration to protect jet-engines from being damaged by large birds, bullets, or airborne objects, such as meteoritic debris while taking off, landing, or flying. This is an improvement in the prevention of the ingestion of birds or other particles from being sucked into the jet-engines and causing all of these unnecessary airplane crashes.

### FIELD OF INVENTION

This invention also relates to intake guards for jet-engines commonly used in aircraft, and is concerned with the provision of an intake device to be used while operating jet-engines, in order to protect jet-engines from being damaged by foreign objects while taking off, landing, or flying.

### SUMMARY OF THE INVENTION

The present invention is concerned with a guard for obstructing the entry of birds or other foreign objects into aircraft jet engines during ground and flight operation. These foreign objects entering the engines can block air passages in the combustor causing either permanent or temporary loss of power. This hazard is particularly great at take off where maximum uninterrupted power is needed and when flocks of birds are most likely to be encountered, especially on the runways.

More particularly, the present invention is concerned with deflecting debris away from the inlets to the engines. In the meantime, various guards and screening devices have been proposed for interception foreign objects in the inlet air stream to a jet engine. Many of these devices are located inside the lip of the engine nacelle or cowl, and such devices retain the intercepted foreign objects within the nacelle.

This invention contemplates the use of a deflector having a surface that is angularly disposed to the opening of the engine nacelle, and the rim of a deflector surface is put on the base component being sat on the air intake structure.

Consequently, the angularly disposed surface deflects the foreign objects out of the air stream as the objects approach the deflector inlet, and an uninterrupted supply of air is assured to the engine at all times.

It is an object of the present invention to provide an improved device for intercepting foreign objects out of the air stream. And another object of this invention is to provide a deflector for jet-engines, which assure an adequate air supply to the engine, to withstand the impact of the foreign objects or birds.

### BRIEF DESCRIPTION OF THE DRAWINGS

FIG. 1 is a perspective view of an aircraft jet engine with a protective device of the present invention.

FIG. 2 is an enlarged partial view of a jet engine of an aircraft provided with a protective guard device attached to the air inlet cowl of an engine.

FIG. 3 is a top view of an aircraft fitted with a jet engine air intake guard for the engine air intake structure.

FIG. 4 is an exploded view of the present invention

FIG. 5 is a perspective view of the present invention, wherein the engine is mounted in pod and supported by an aircraft wing.

FIG. 6 is a frontal view of an aircraft jet engine wihth a protective device of the air inlet cowl of an engine of the present invention.

FIG. 7 is a perspective view of a deflector of the present invention.

FIG. 8 is a view of a mesh of the outer guard.

FIG. 9 is a perspective view of the inner guard with an enlarged formation of the mesh.

FIG. 10 is a detailed view of a base of the present invention.

FIG. 11 is a perspective view of a base part filled on the air intake cowl of engine of the present invention.

FIG. 12 is a perspective and exploded view of the present invention.

FIG. 13 is an enlarged sectional view of the present invention.

FIG. 14 is a partial sectional view of a jet engine and protective guard.

FIG. 15 is a sectional view of the flow of air through a fitted device.

### DETAILED DESCRIPTION OF A PREFERRED EMBODIMENT

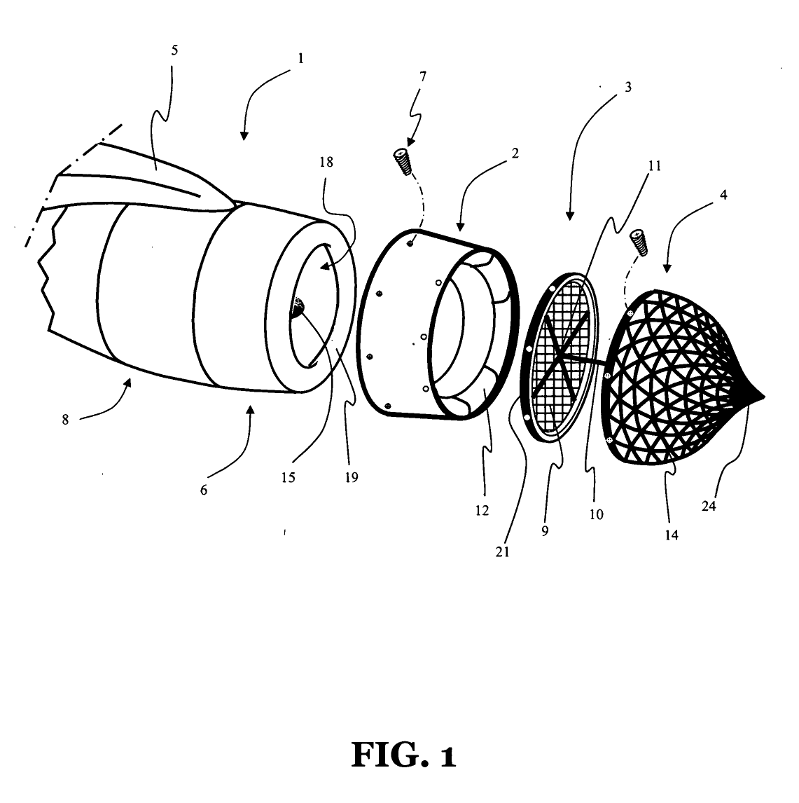

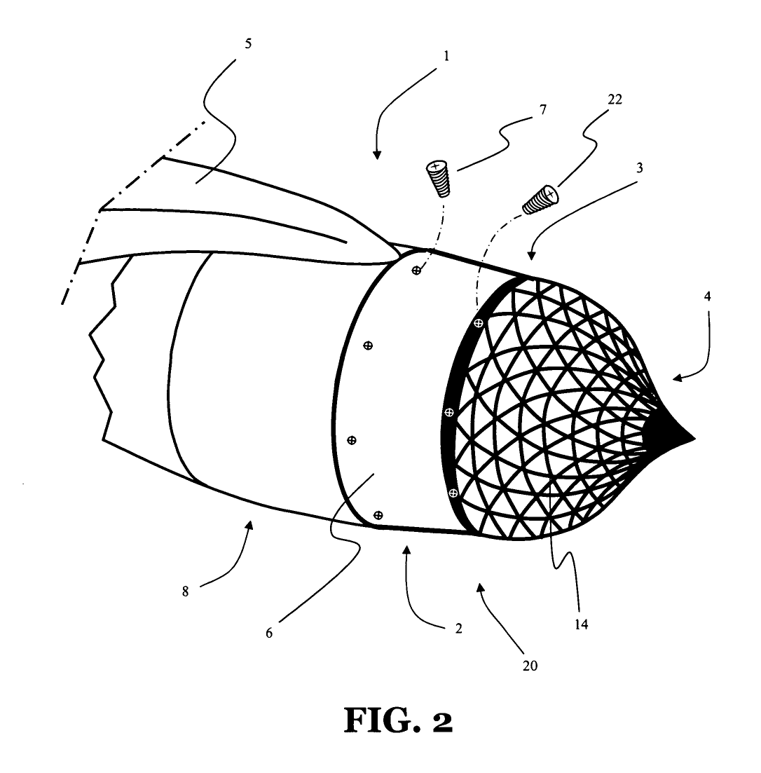

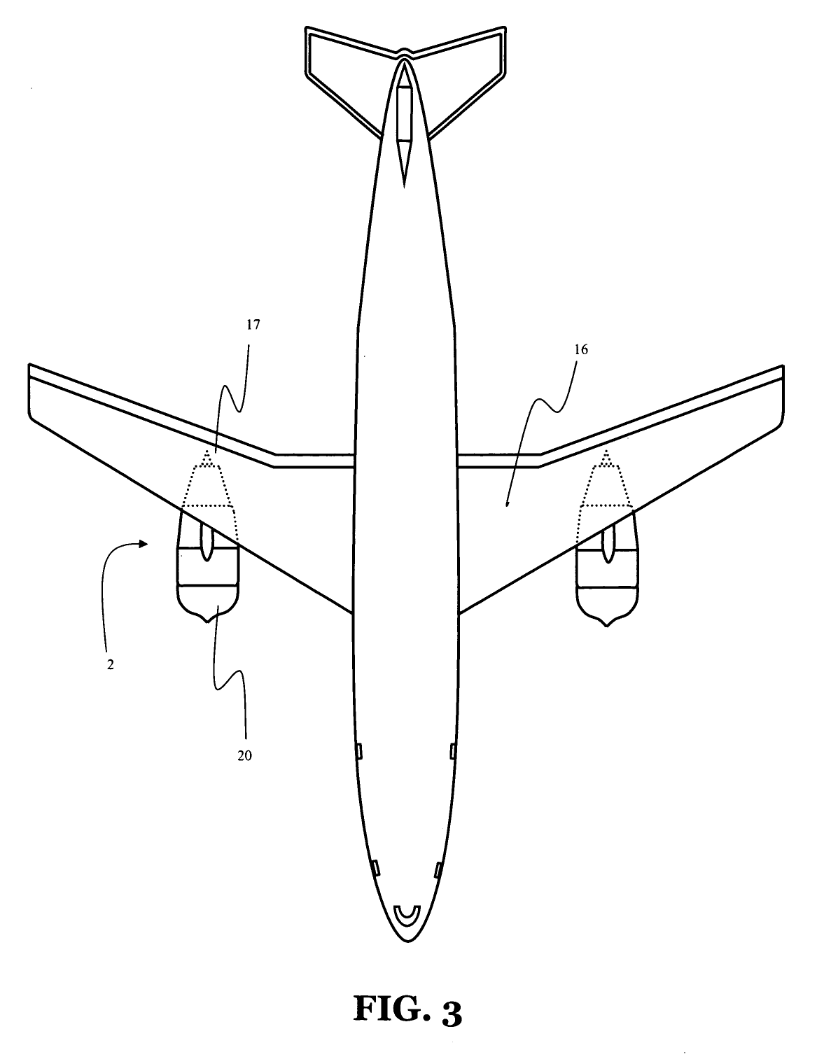

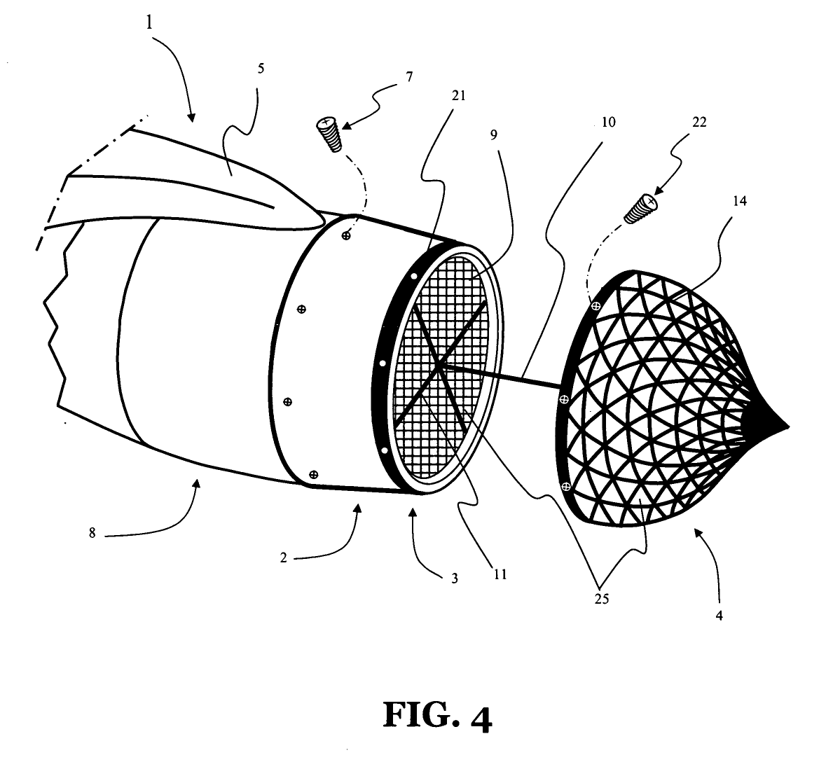

Referring to the drawing, there is a diagrammatically illustrated in FIG. 1, the air inlet structure (26) for a jet-engine (1), designed to be installed on an aircraft through a mast (5) mounted in pod and supported by aircraft wing (16), the engine (15) being practically the same as that shown in FIGS. 2, 4 and 5. Furthermore, the engine inlet (18) allows air for the support of combustion (16) gases exits at tail pipe (17).

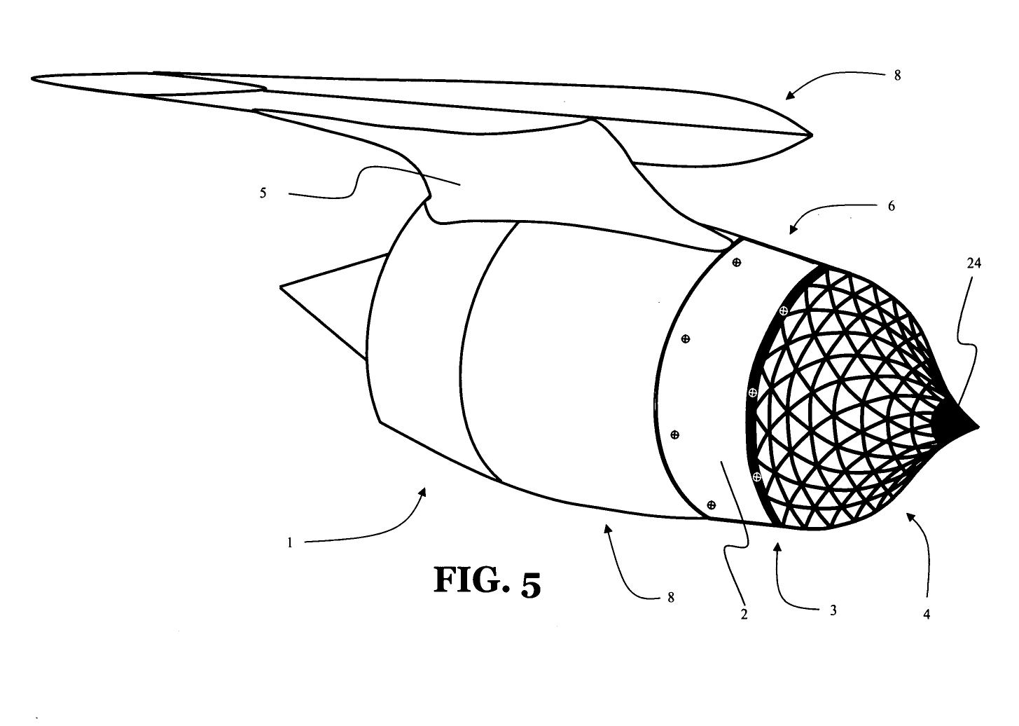

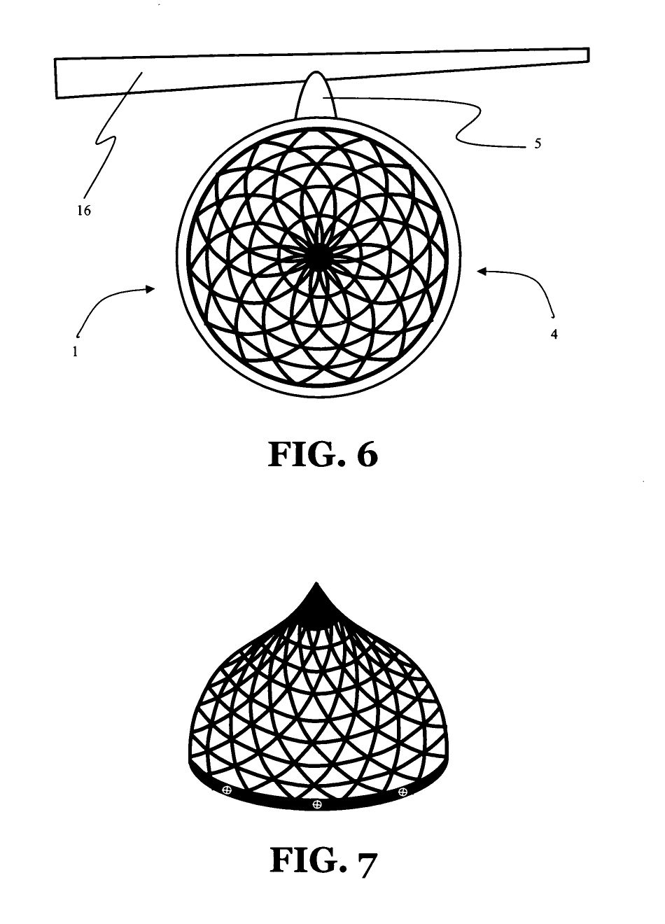

Still with reference to FIG. 5, the figure is showing a protective device (20) according to a preferred embodiment of this invention. In particular, this device (20) may be assembled on the air inlet structure (26) during use, in order to avoid the entry of any foreign objects inside the engine 15.

The protective device (20) is essentially provided with the protective meshes (9) and (14) on a secondary device (3) and deflector (4). The deflector (4) comprises a plurality of geodesic lines (14) with a triangular mechanism, and is mounted on the top of a base component of the protective device (2).

And the secondary device (3) is inserted to the inside rim of the deflector (4) using metal screws (22) to hold two devices (3) and (4) firmly together.

The polycarbonate plastic is a suitable material for this deflector (4) of the present invention. Since this polycarbonate is a vary durable material, which has high impact-resistance and low scratch-resistant, it can be laminated to make bullet-proof glass, the cockpit canopy of a jet fighter and a pilot windshield would be more accurate. This polycarbonate plastic is also highly transparent to visible light and has better light transmission characteristics than many kinds of glass. The deflector (4) of this invention is probably the largest piece of its type formed in the world.

Since the titanium alloy is a strong, light metal, it is an appropriate material for this metal-mesh screen (2) of this invention. Titanium alloy is as strong as steel but 45% lighter, and is also twice as strong as aluminum but only 60% heavier, is used in airplanes, missiles and rockets where strength, low weight and resistance to high temperatures are important. Unfortunately, the high costs of titanium and polycarbonate have limited its widespread use.

The interstices between the spaced members (9) and (25) of a deflector (4) and a secondary device (3) must be sufficiently large for adequate air to the inlet (18) yet sufficiently small to intercept birds or any foreign objects ingested by the engine (15), since the most of the jet-engines are designed to survive strikes from 4-pound birds.

The forward tip (23) of the center post (10), titanium alloy rod, of a secondary device (9) is rigidly welded to the inside rim of a screen (21) beneath the deflector (4), in order to withstand the impact of the foreign objects or birds, and to prevent unnecessary retention of the debris on the deflector (2).

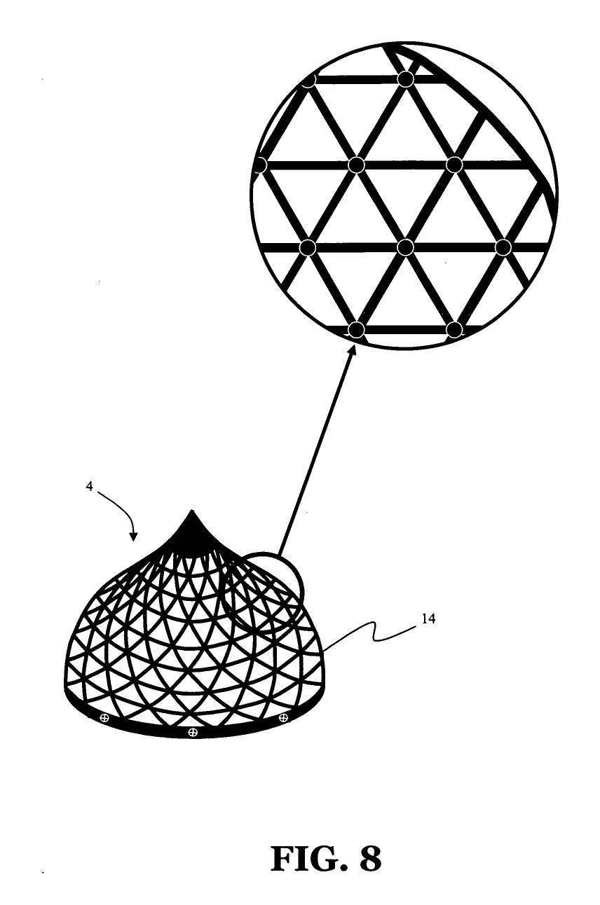

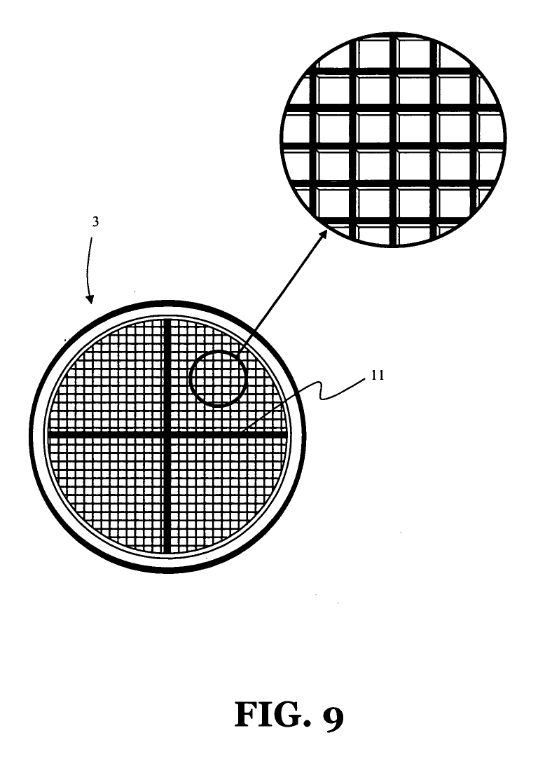

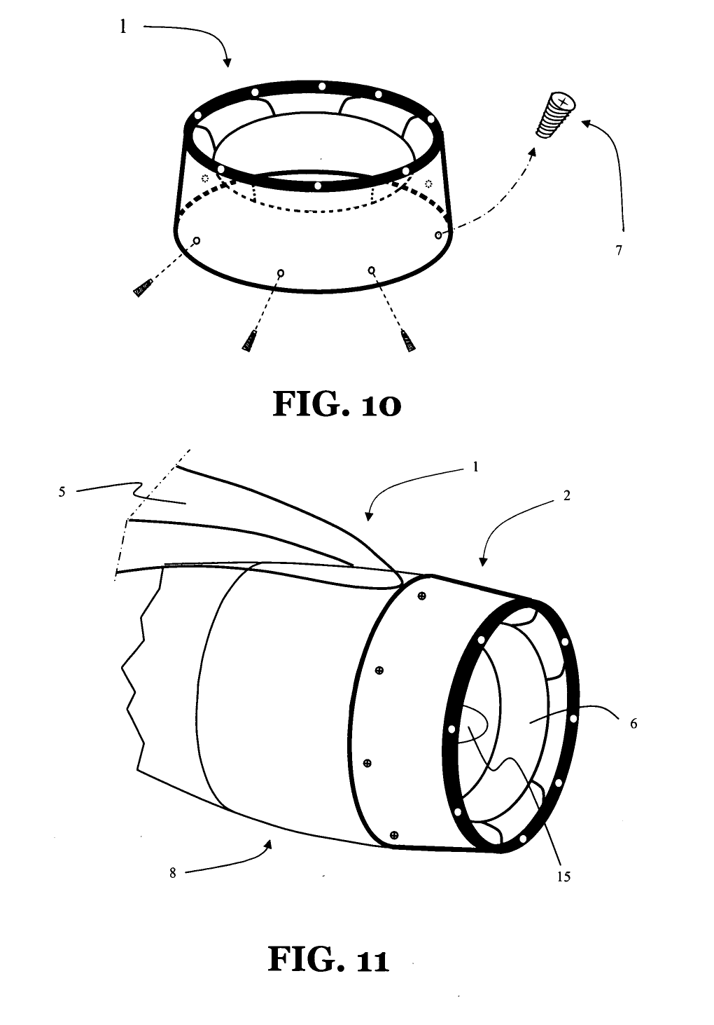

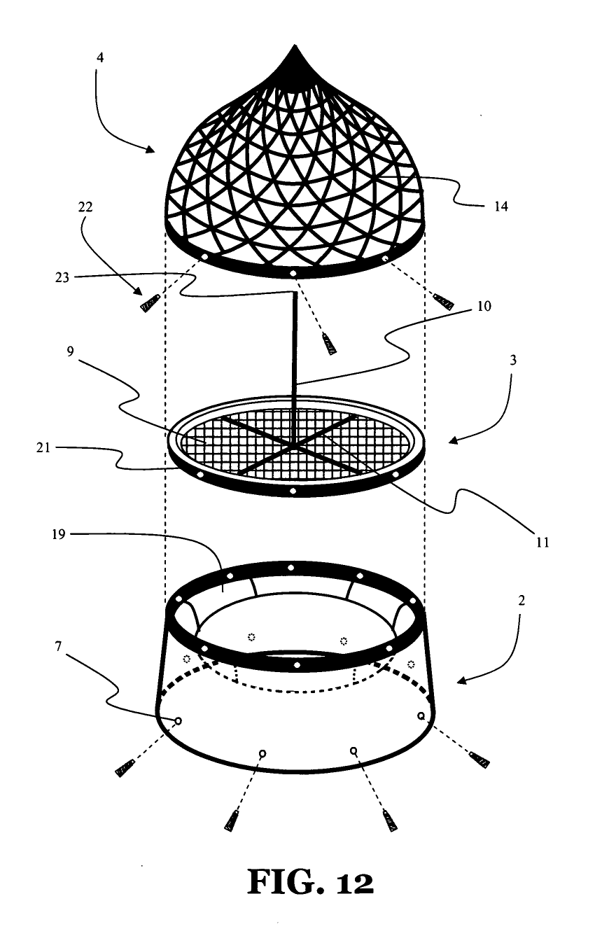

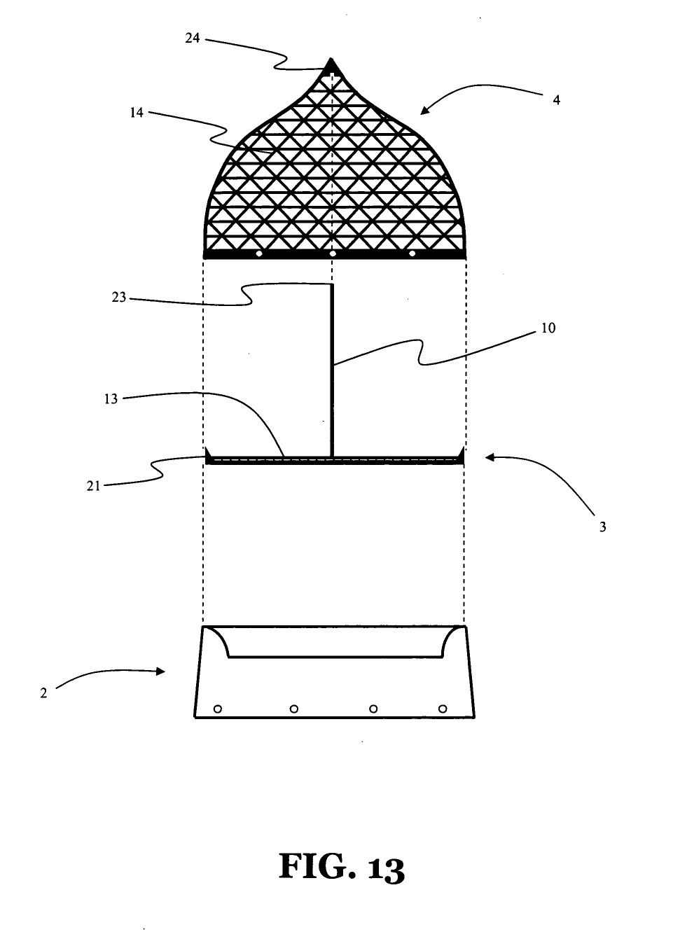

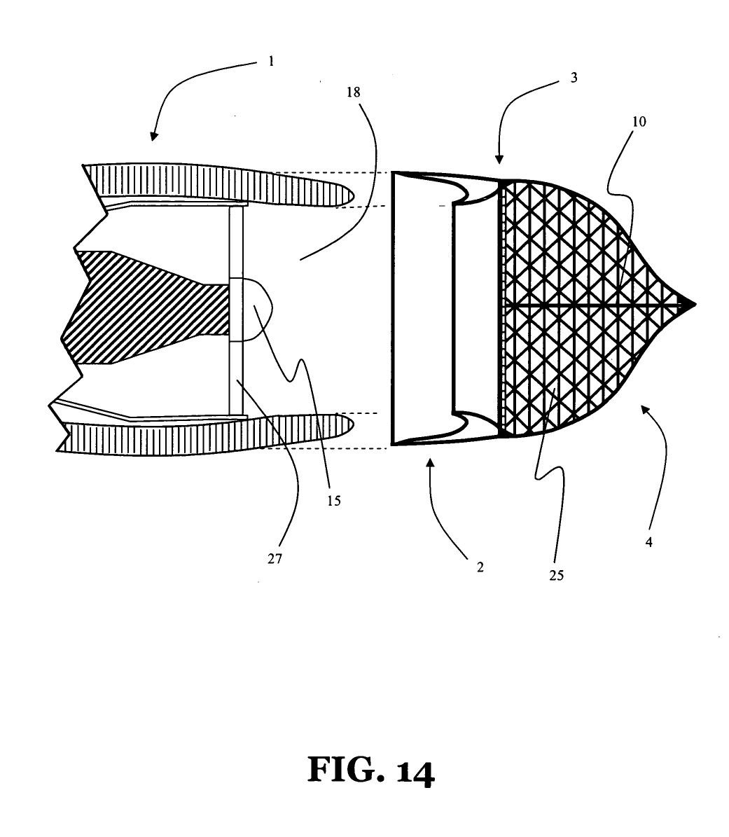

The crossed-bars (11) on a secondary device (3) has an important feature of the invention shown in FIG. 8, in order to maintain the stability of a metal-mesh screen (9) and the center post (10) against the strong air flow into the jet-engine inlet (18).

The base component (2) of this invention can be mounted over the air inlet cowl (26) using metal screws (7) in order to merge the two devices (2) and (4) together.

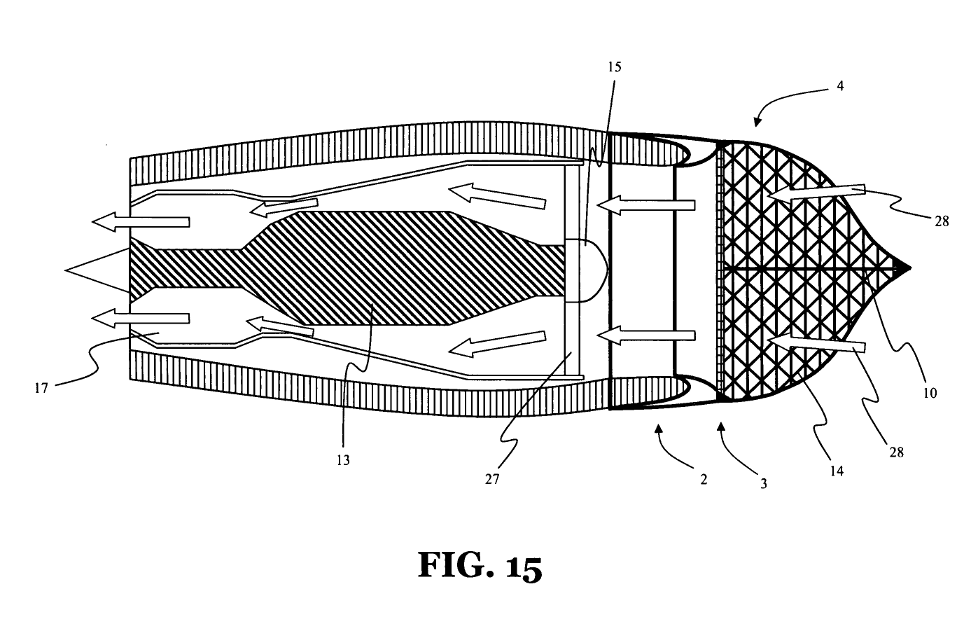

More particularly, the inlet air stream for the engine (23) normally flows through the deflector (4) as shown by the arrow (28) in FIG. 15, and moreover this present invention is designed with a sufficient angle to prevent any blockages of the dome surface of a deflector (2) in any circumstances.

What is claimed is:

1. A jet engine air intake guard characterized in that the main portion of the double protective device is approximately in the shape of a steep-angled dome, in order to prevent any blockages of a portion of the dome surface of a deflector in any circumstances, and the secondary device, a metal-mesh screen, is fitted between the deflector, and the base component is mounted over the air inlet cowl using metal screws to prevent any debris being sucked into the jet-engine from impacted any foreign objects or birds on a deflector in any circumstances.

2. The jet engine air intake guard from claim 1l characterized in that the base component of this invention is mounted over the air inlet cowl using metal screws to hold a secondary device and a deflector firmly together.

3. The jet engine air intake guard from claim 1, characterized in that the protective device is made by polycarbonate plastic and titanium alloy, which have high impact-resistance, scratch-resistance, rigidity and lightweight, in order to withstand the impact of the foreign objects or birds on a deflector.
